(19) United States
(12) Patent Application Publication
(10) Pub. No.: US 2026/0288211 A1
(43) Pub. Date: Sep. 24, 2026

(54) HINGE DEVICE

(71) Applicant: FOSITEK CORPORATION, New Taipei City (TW)

(72) Inventors: Yung-Chih Tseng, New Taipei City (TW); Zoen Ryon Ryan Wong, New Taipei City (TW); Chun-Han Lin, New Taipei City (TW)

(73) Assignee: FOSITEK CORPORATION, New Taipei City (TW)

(21) Appl. No.: 19/208,123

(22) Filed: May 14, 2025

(30) Foreign Application Priority Data
Mar. 21, 2025 (TW) 114110702

(51) Int. Cl. G06F 1/16

(52) U.S. Cl. CPC G06F 1/1681

(57) ABSTRACT

A hinge device includes a base seat, a swing lever, a rotation member, and a limitation unit. The base seat has a first engagement groove and a second engagement groove. The swing lever is mounted on the base seat and is pivotable between an initial position and a movement position. The rotation member is mounted on the swing lever and is rotatable between a first position, a transition position and a second position. The rotation member has a first slide portion that slidably extends through the first engagement groove, and a second slide portion that is slidable along the second engagement groove. The limitation unit is mounted on the rotation member and is operable to be driven by the rotation member to switch between a restriction state, where the swing lever is limited at the initial position, and a liberation state, where the swing lever is not limited.

### CROSS-REFERENCE TO RELATED APPLICATION

This application claims priority to Taiwanese Invention Patent Application No. 114110702, filed on Mar. 21, 2025, the entire disclosure of which is incorporated by reference herein.

The disclosure relates to a hinge device, and more particularly to a hinge device for an electronic device such as a laptop.

### BACKGROUND

Typically, an electronic device such as a laptop has a first housing (e.g., the system side) and a second housing (e.g., the display side), and exhaust vents for heat dissipation are usually located at the lower rear of the first housing. During opening and shutting of the electronic device, the second housing may obstruct the exhaust vents, thereby affecting the heat dissipation performance of the electronic device.

### SUMMARY

Therefore, an object of the disclosure is to provide a hinge device that can alleviate at least one of the drawbacks of the prior art.

According to the disclosure, the hinge device includes a base seat, a swing lever, a rotation member, a limitation unit. The base seat has a first engagement groove and a second engagement groove that are recessed in a left-right direction. The first engagement groove has a curved shape, and the second engagement groove has a guide portion. The swing lever is mounted on the base seat and is pivotable about a first axis, which extends in the left-right direction (D2), relative to the base seat between an initial position and a movement position. The rotation member is mounted on the swing lever and is rotatable about a second axis, which extends in the left-right direction, relative to the swing lever between a first position, a transition position and a second position. The rotation member has a first slide portion that slidably extends through the first engagement groove, and that extends along the second axis, and a second slide portion that is slidable along the second engagement groove. The limitation unit is mounted on the rotation member and is operable to be driven by the rotation member. The limitation unit is able to switch between a restriction state, where the swing lever is limited at the initial position, and a liberation state, where the swing lever is not limited. When the rotation member is at the first position, the limitation unit is in the restriction state, and the swing lever is at the initial position. When the rotation member rotates from the first position to the transition position, the limitation unit is driven by the rotation member to switch into the liberation state, and the swing lever is at the initial position. When the rotation member rotates from the transition position to the second position, the swing lever is at the movement position, and the second slide portion slides along the guide portion of the second engagement groove.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a fragmentary perspective view illustrating an embodiment of a hinge device according to the disclosure, where a connection frame of a rotation member of the embodiment is omitted.

FIG. 2 is a perspective view of the embodiment.

FIG. 3 is a partly exploded perspective view of FIG. 1.

FIG. 4 is a partly exploded perspective view of FIG. 2.

FIG. 5 is a partly sectional view of the embodiment, where the rotation member is at a first position.

FIG. 6 is a sectional view of the embodiment, where the rotation member is at the first position.

FIG. 7 is a partly sectional view of the embodiment, where the rotation member rotates from the first position toward a transition position.

FIG. 8 is a sectional view of the embodiment, where the rotation member rotates from the first position toward the transition position.

FIG. 9 is a partly sectional view of the embodiment, where the rotation member is at the transition position.

FIG. 10 is a sectional view of the embodiment, where the rotation member is at the transition position.

FIG. 11 is a partly sectional view of the embodiment, where the rotation member rotates from the transition position toward a second position.

FIG. 12 is a sectional view of the embodiment, where the rotation member rotates from the transition position toward the second position.

FIG. 13 is a partly sectional view of the embodiment, where the rotation member is at the second position.

FIG. 14 is a sectional view of the embodiment, where the rotation member is at the second position.

### DETAILED DESCRIPTION

It should be noted herein that for clarity of description, spatially relative terms such as “top,” “bottom,” “upper,” “lower,” “on,” “above,” “over,” “downwardly,” “upwardly” and the like may be used throughout the disclosure while making reference to the features as illustrated in the drawings. The features may be oriented differently (e.g., rotated 90 degrees or at other orientations) and the spatially relative terms used herein may be interpreted accordingly.

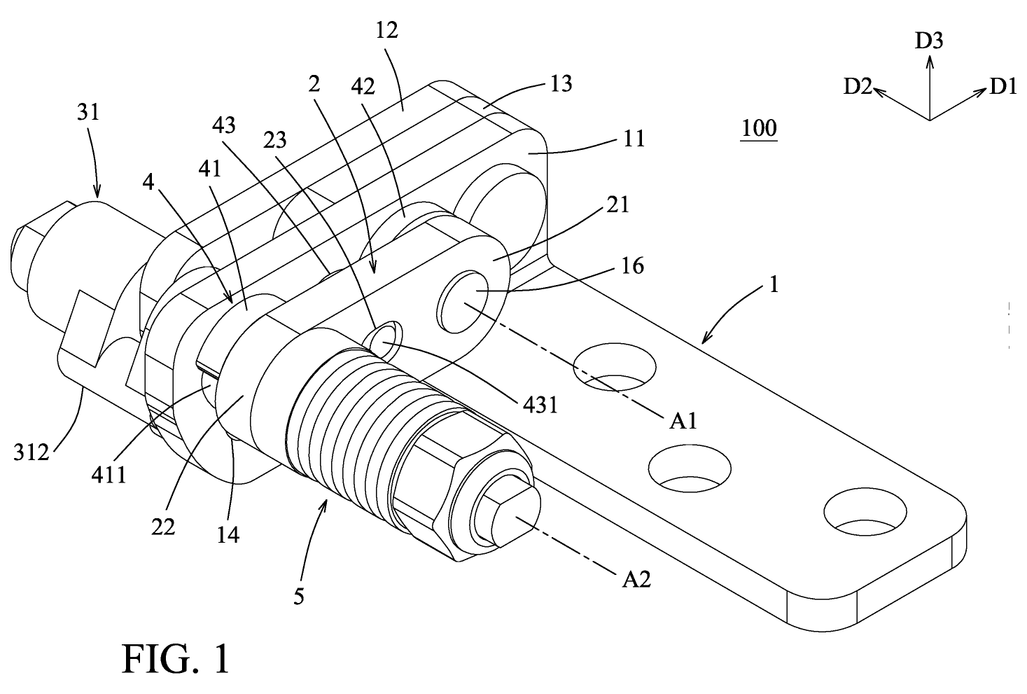

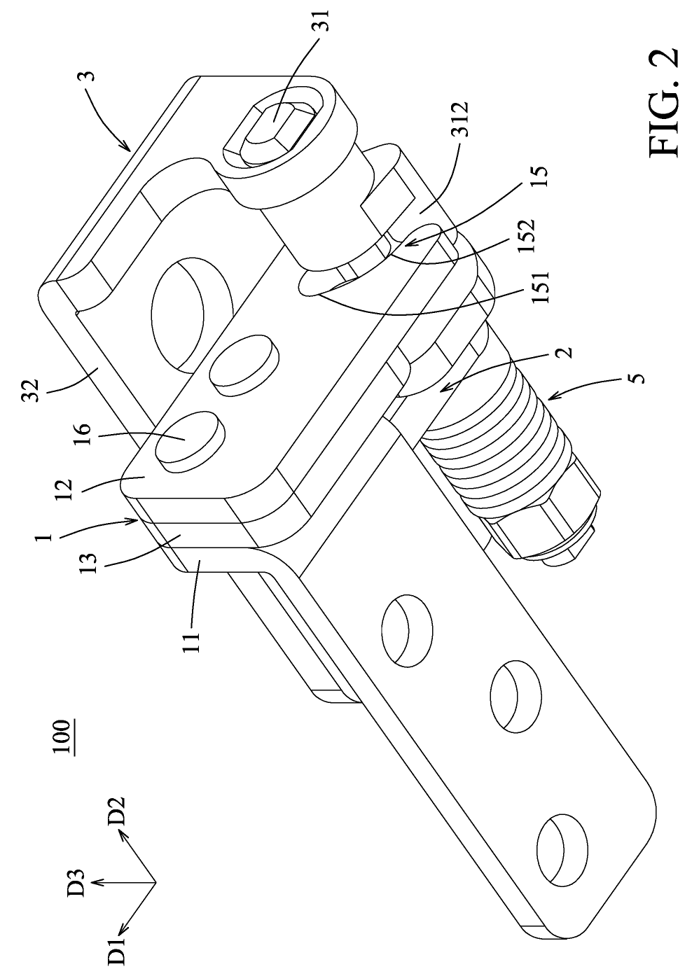

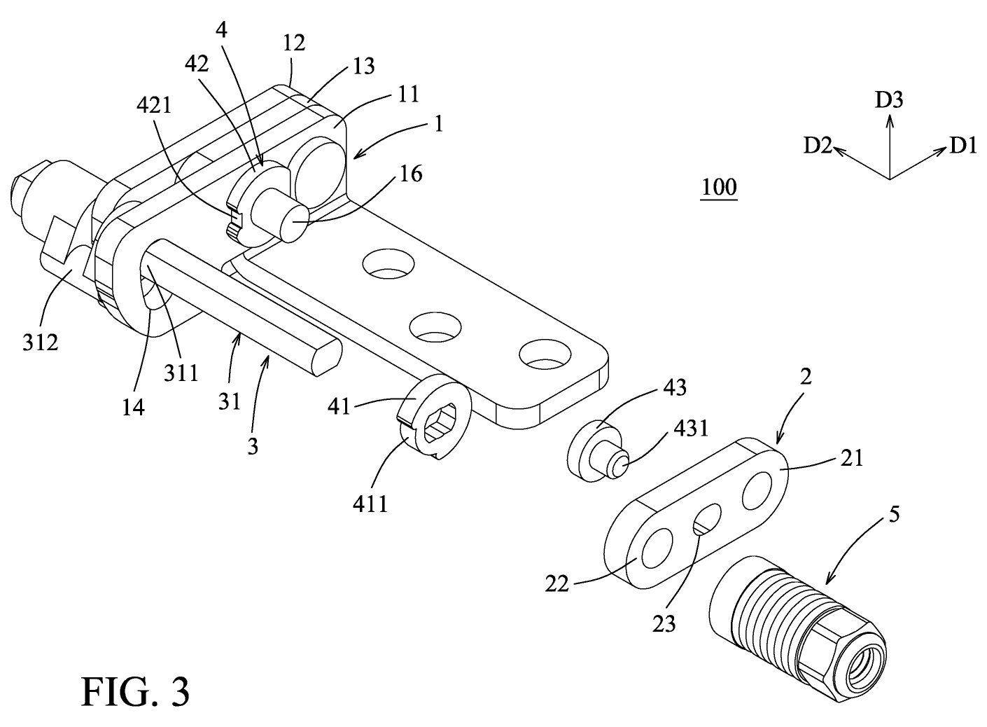

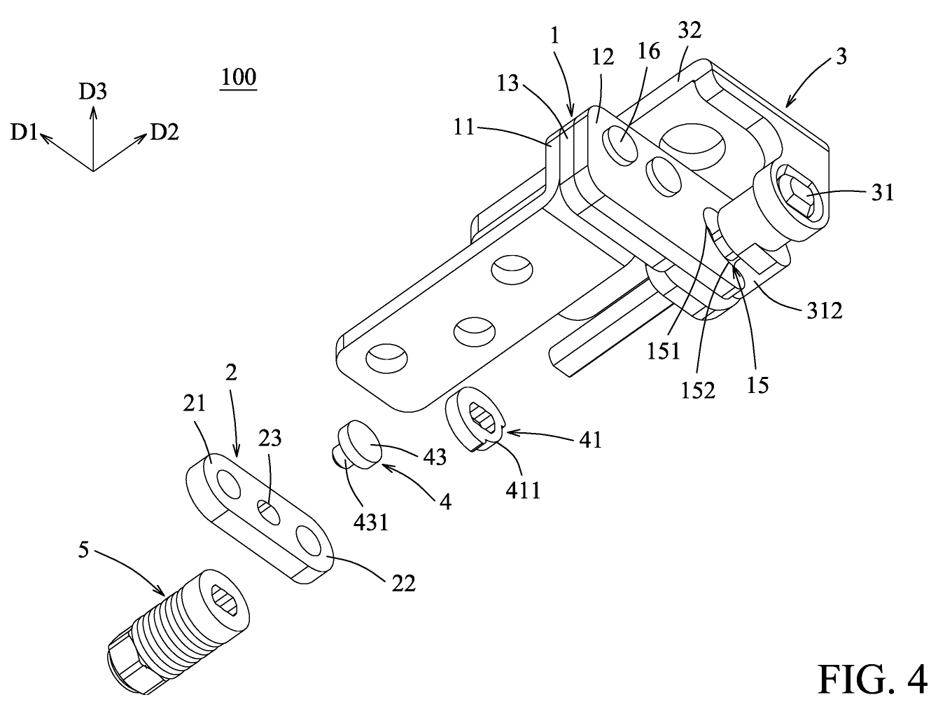

Referring to FIGS. 1-4, an embodiment of a hinge device 100 according to the disclosure is adapted for an electronic device (not shown) such as a laptop, but is not limited thereto. The electronic device includes a first case body that may be provided with a keyboard and a touch area, a second case body that may be provided with a screen. The first and second case bodies are connected to each other by the hinge device 100, so that the second case body is movable relative to the first case body, i.e., the electronic device can be opened and shut. The hinge device 100 includes a base seat 1, a swing lever 2, a rotation member 3 and a limitation unit 4.

It should be noted that, in the following description, a front-rear direction (D1) faces forwards, a direction opposite to the front-rear direction (D1) faces rearwards. A left-right direction (D2) is transverse to the front-rear direction (D1), and faces leftwards. A direction opposite to the left-right direction (D2) faces rightwards. A top-bottom direction (D3) is transverse to the front-rear direction (D1) and the left-right direction (D2), and faces upwards. A direction opposite to the top-bottom direction (D3) faces downwards.

Referring to FIGS. 1-4, the base seat 1 is adapted to be disposed on a rear side of the first case body in the front-rear direction (D1), and has a first seat body 11 and a second seat body 12 that are arranged in the left-right direction (D2), a separation plate body 13 that is disposed between the first and second seat bodies 11, 12, a first engagement groove 14 and a second engagement groove 15 that are recessed in the left-right direction (D2), and that are respectively formed in the first and second seat bodies 11, 12, and a pivot portion 16 that extends along a first axis (A1), and that extends through the first and second seat bodies 11, 12 and the separation plate body 13. The first axis (A1) extends in the left-right direction (D2). Since the first engagement groove 14 and the second engagement groove 15 are respectively formed in the first and second seat bodies 11, 12 that are arranged in the left-right direction (D2), and that are spaced apart from each other by the separation plate body 13, the first engagement groove 14 and the second engagement groove 15 are spaced apart from each other in the left-right direction (D2). The first engagement groove 14 has a curved shape. The second engagement groove 15 has a guide portion 151, and an arc portion 152 that is in spatial communication with the guide portion 151 at an end thereof, that opens at another end thereof opposite to the guide portion 151, and that has an arc shape. In this embodiment, the guide portion 151 is straight and is tangent to the arc portion 152, but in other embodiments, the guide portion 151 may have other configurations according to requirements.

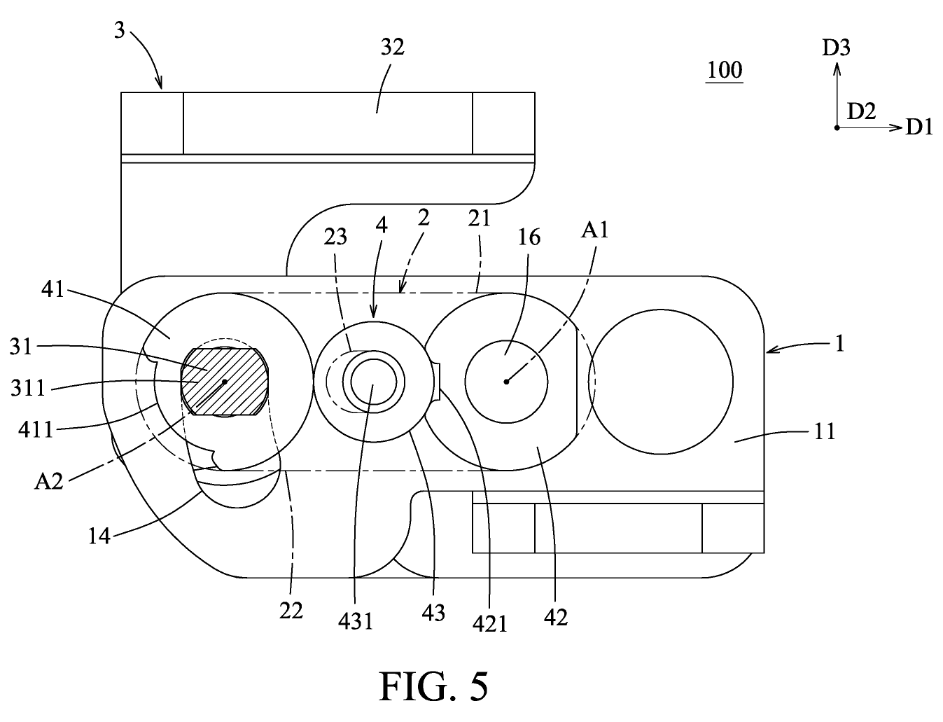

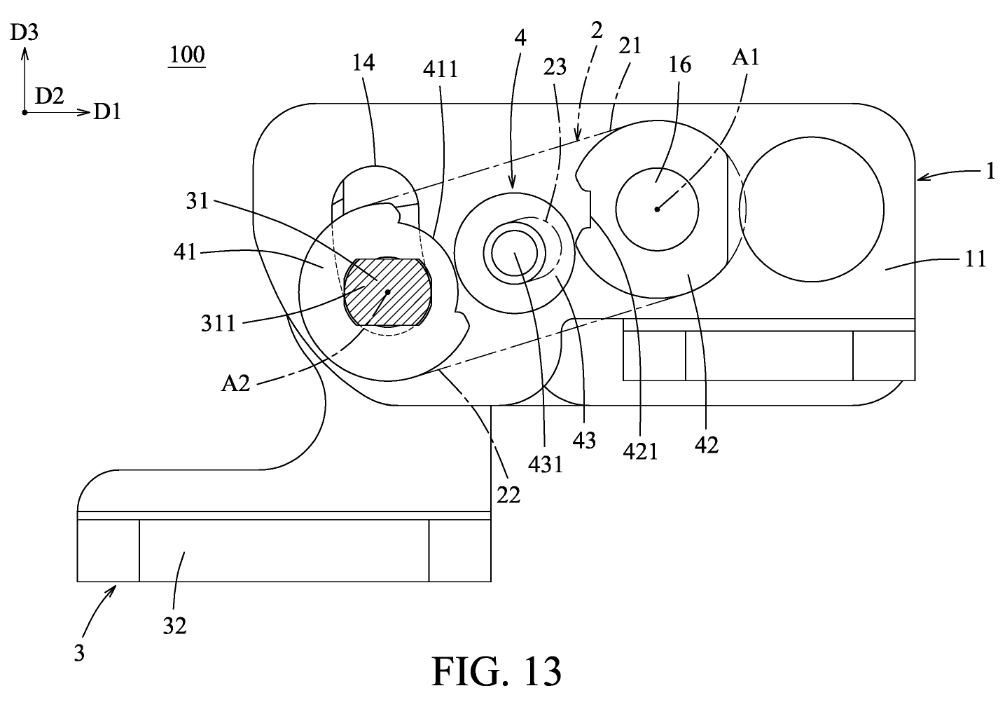

The swing lever 2 is mounted on the base seat 1 and is pivotable about the first axis (A1) relative to the base seat 1 between an initial position and a movement position. The swing lever 2 has a first end portion 21 that is connected to the pivot portion 16, a second end portion 22 that is opposite to the first end portion 21, and a slide groove 23 that is recessed in the left-right direction (D2), that is located between the first end portion 21 and the second end portion 22, and that is elongated in the front-rear direction (D1). When the swing lever 2 is at the initial position, the second end portion 22 is at a higher position in the top-bottom direction (D3) (see FIG. 5), and when the swing lever 2 is at the movement position, the second end portion 22 is at a lower position in the top-bottom direction (D3) (see FIG. 13).

The rotation member 3 is mounted on the swing lever 2 and is rotatable about a second axis (A2), which extends in the left-right direction (D2), relative to the swing lever 2 between a first position, a transition position and a second position. Specifically, the rotation member 3 rotatably extends through the second end portion 22 of the swing lever 2. The rotation member 3 includes a rotation body 31 that rotatably extends through the second end portion 22 of the swing lever 2, and a connecting frame 32 that is mounted to the rotation body 31 and that is adapted for disposing the second case body. The rotation body 31 has a first slide portion 311 that slidably extends through the first engagement groove 14, and that extends along the second axis (A2), and a second slide portion 312 that is slidable along the second engagement groove 15. The arc portion 152 of the second engagement groove 15 has a radius of curvature that is equal to a distance between a center of the second slide portion 312 and the second axis (A2).

The limitation unit 4 is mounted on the rotation member 3 and is operable to be driven by the rotation member 3 to move. The limitation unit 4 is able to switch between a restriction state, where the swing lever 2 is limited at the initial position, and a liberation state, where the swing lever 2 is not limited. The limitation unit 4 has a driver member 41 that is mounted on the rotation member 3, and that is operable to be driven by the rotation member 3 to pivot synchronously, a secure member 42 that is disposed on the base seat 1 (specifically, that is integrally and fixedly formed on the pivot portion 16), and a slider member 43 that is mounted to the swing lever 2 and that is located between the driver member 41 and the secure member 42. The base seat 1 and the swing lever 2 define an accommodation space therebetween, and the accommodation space accommodates the driver member 41, the secure member 42 and the slider member 43. The driver member 41 has a first accommodation portion 411, the secure member 42 has a second accommodation portion 421, and the slider member 43 has a slide protrusion 431 that is slidably disposed in the slide groove 23. The slider member 43 is slidable, relative to the swing lever 2, between the driver member 41 and the secure member 42 to be partially received in the first accommodation portion 411 and/or the second accommodation portion 421.

In some embodiments, the hinge device may further include a torque module 5 that is sleeved on the rotation member 3 (specifically, on the rotation body 31 of the rotation member 3), that abuts against the swing lever 2, and that is operable to be driven by the rotation member 3 to rotate. When the rotation member 3 rotates (i.e., when the electronic device is opened or shut), the torque module 5 and the swing lever 2 may resist rotation of the rotation body 31 by friction generated therebetween, so that the electronic device may be positioned at different angles, thereby increasing the hand feel during the user opening or shutting the electronic device.

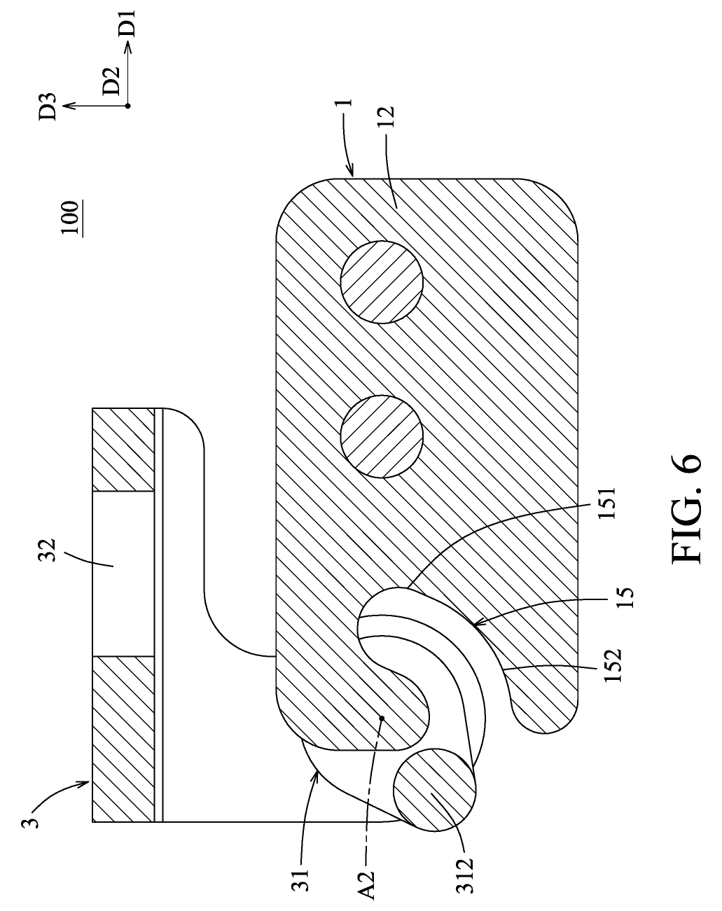

Referring to FIGS. 5 and 6, when the rotation member 3 is at the first position, the second case body covers the first case body (that is, the electronic device is shut), the limitation unit 4 is in the restriction state, and the swing lever 2 is at the initial position. The first accommodation portion 411 of the driver member 41 is oriented away from the slider member 43, the slider member 43 cannot be slid and is partially received in the second accommodation portion 421 of the secure member 42, so that the swing lever 2 cannot be pivoted relative to the base seat 1 and remains at the initial position. At this time, the second slide portion 312 does not enter the second engagement groove 15.

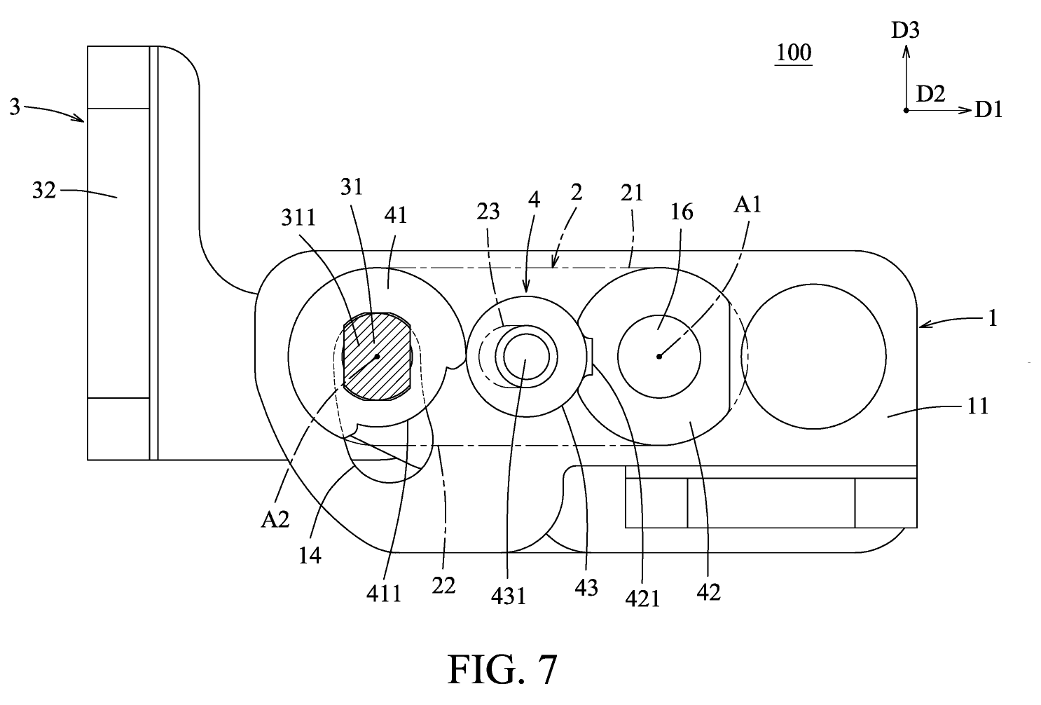

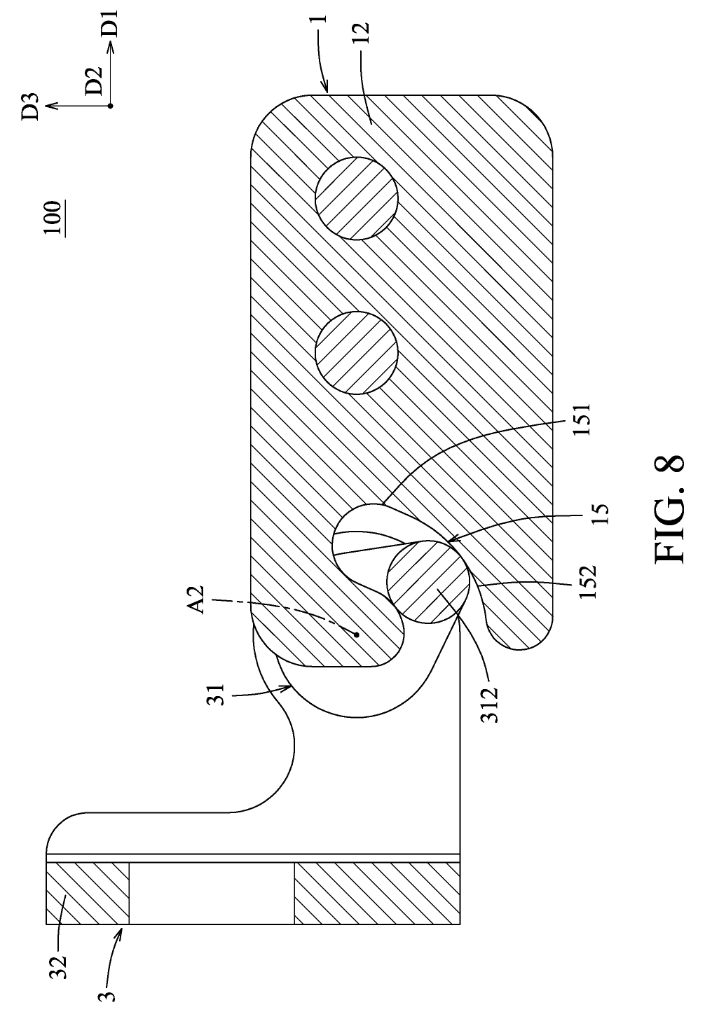

Referring to FIGS. 7 and 8, when the rotation member 3 rotates from the first position toward the transition position such that an angle between the second case body and the first case body is about 90˚, the limitation unit 4 is still in the restriction state, so that the swing lever 2 cannot be pivoted relative to the base seat 1 and is at the initial position. At this time, the second slide portion 312 enters the second engagement groove 15; specifically, the second slide portion 312 slides along the arc portion 152 of the arc engagement groove 15.

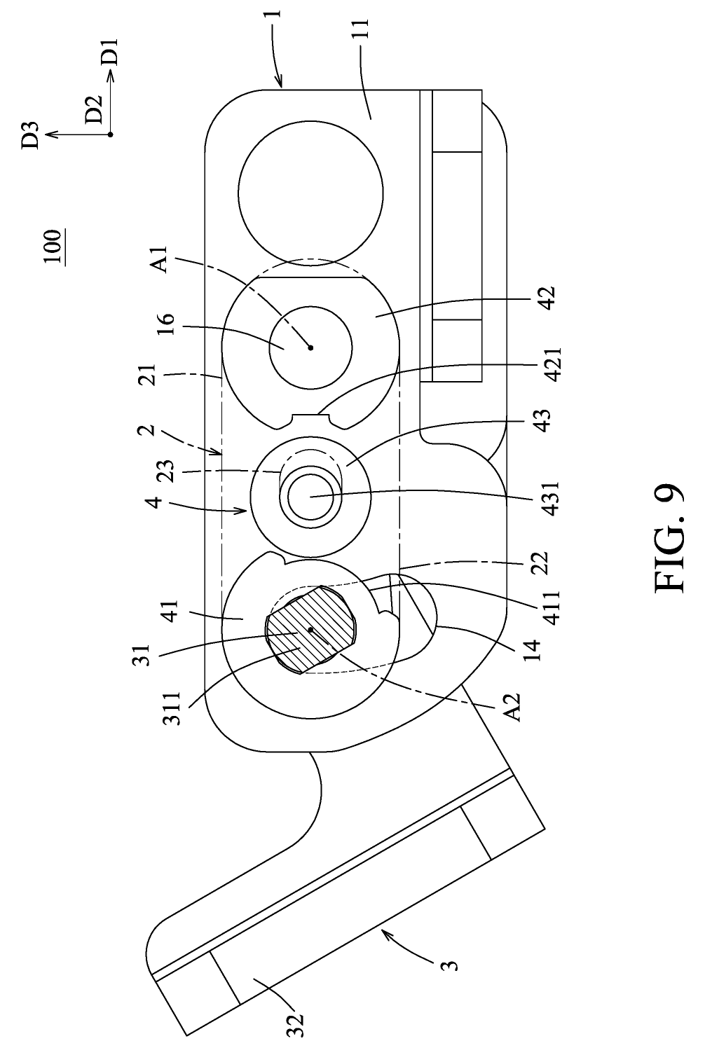

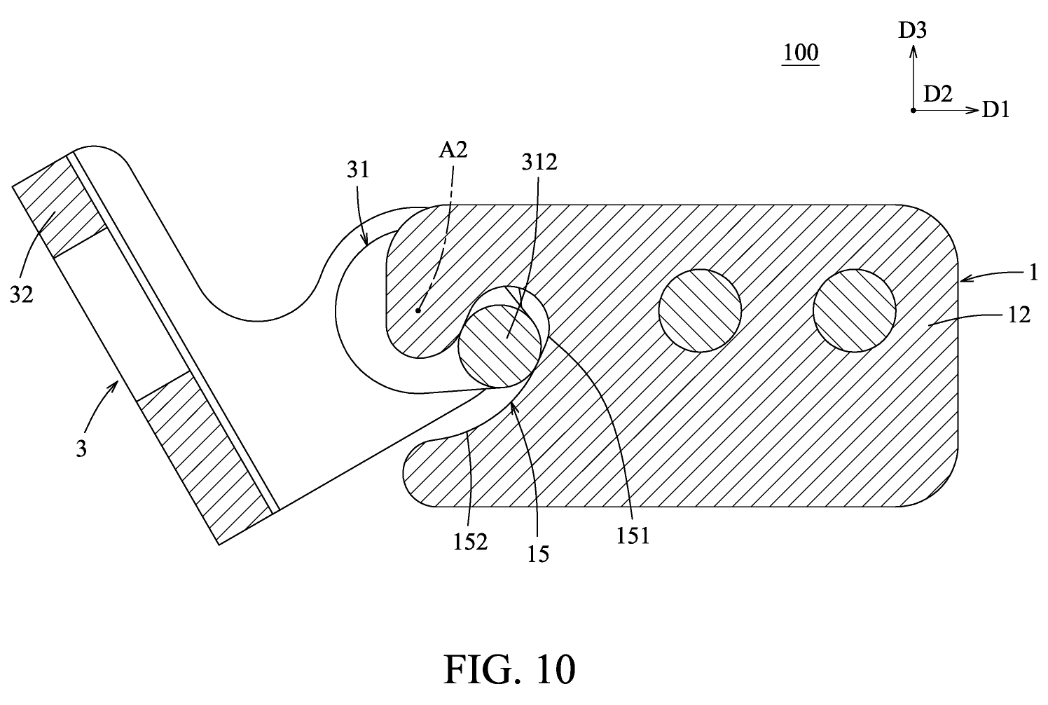

Referring to FIGS. 9 and 10, when the rotation member 3 rotates to the transition position, the angle between the second case body and the first case body is about 120˚, the limitation unit 4 is driven by the rotation member 3 to switch into the liberation state, and the second slide portion 312 slides along the arc portion 152 to a junction between the guide portion 151 and the arc portion 152. When the rotation member 3 is at the transition position, the limitation unit 4 is in the liberation state, the first accommodation portion 411 of the driver member 41 is oriented toward the slider member 43, and the slider member 43 is slidable to be partially received in the first accommodation portion 411 and/or the second accommodation portion 421. At this time, since the slider member 43 is not limited by the driver member 41 and the second accommodation portion 421, the slider member 43 may move downwards, so that the swing lever 2 is not limited at the initial position and is pivotable relative to the base seat 1. However, the swing lever 2 remains at the initial position.

When the rotation member 3 rotates from the first position to the transition position, the swing lever 2 is limited at the initial position by the limitation unit 4, causing the rotation body 31 to be at a high position in the top-bottom direction (D3), so that the second case body that is disposed on the rotation member 3 is at a high position, thereby preventing the second case body from blocking exhaust vents (for heat dissipation) of the electronic device that are located at the lower rear of the first case body.

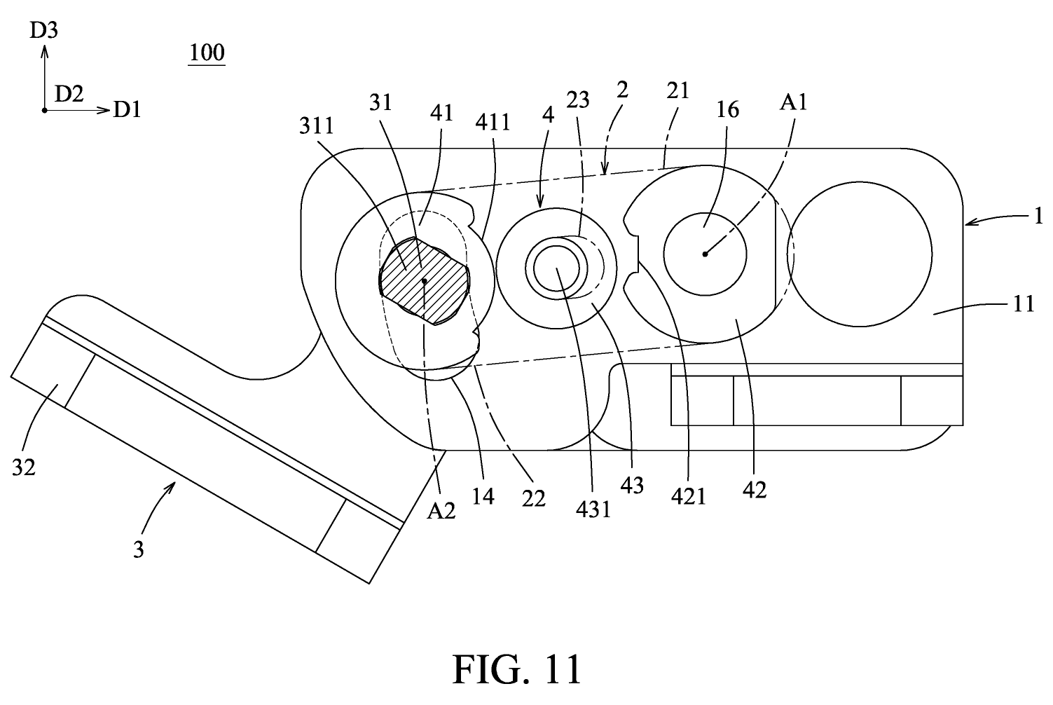

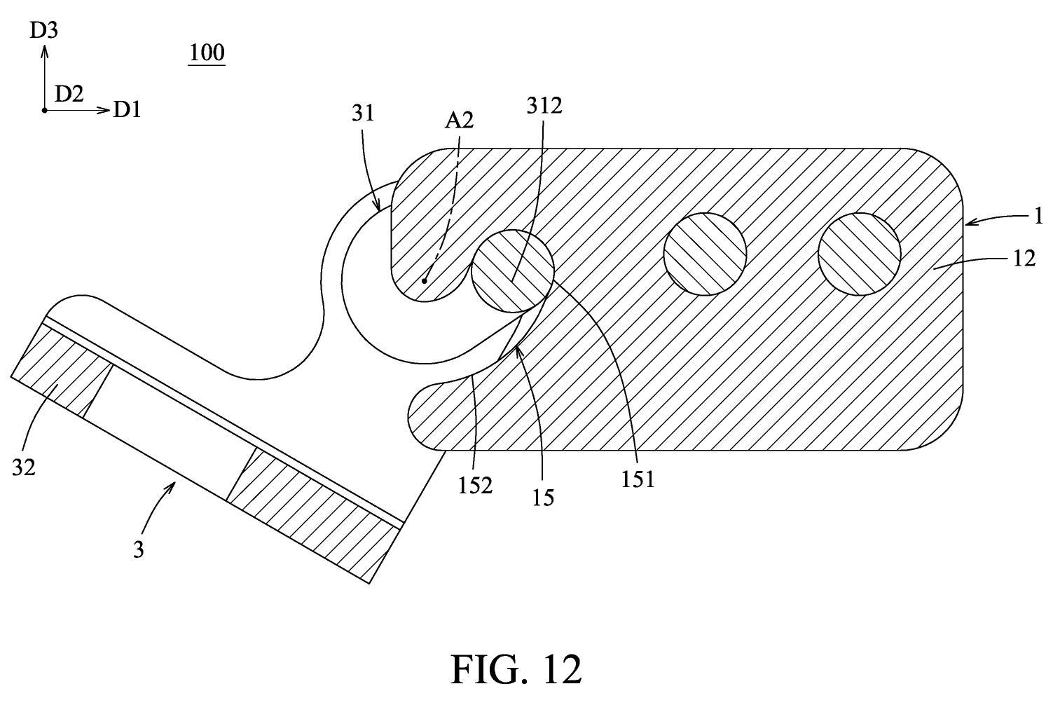

Referring to FIGS. 11 and 12, when the rotation member 3 rotates from the transition position toward the second position such that the angle between the second case body and the first case body is about 150˚, the limitation unit 4 is still in the liberation state, and the swing lever 2 is between the initial position and the movement position (i.e., is pivoted toward the movement position), so that the rotation body 31 (and the second axis (A2)) is at a lower position in the top-bottom direction (D3). At this time, the second slide portion 312 slides to a terminal end of the guide portion 151.

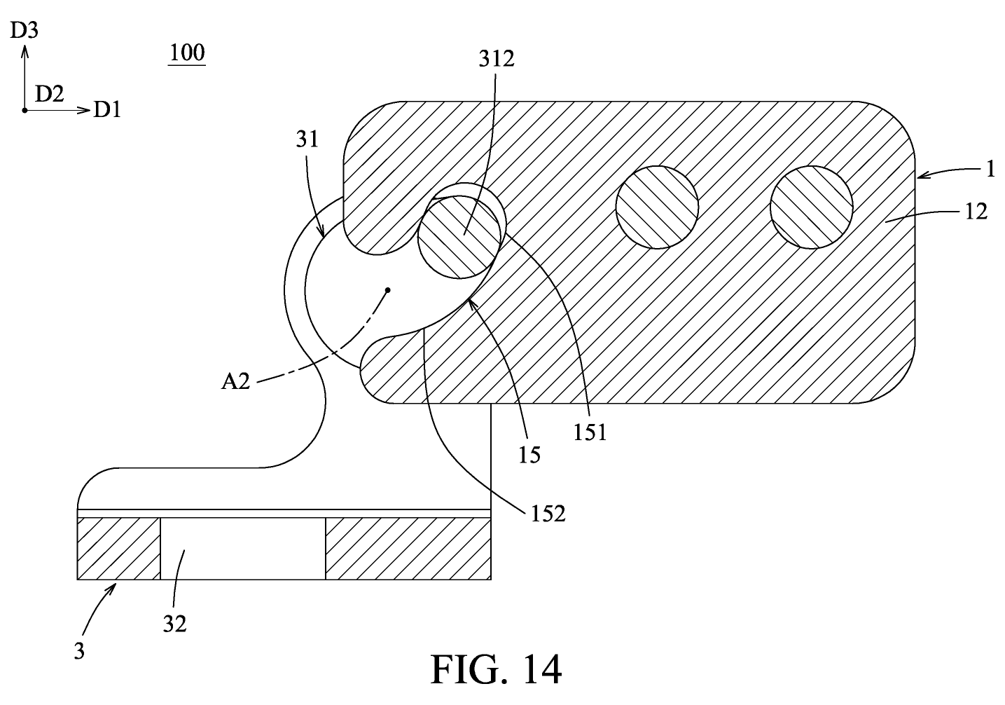

Referring to FIGS. 13 and 14, when the rotation member 3 rotates to the second position, the angle between the second case body and the first case body is about 180˚, and the second slide portion 312 slides along the guide portion 151 of the second engagement groove 15. When the rotation member 3 is at the second position, the limitation unit 4 is still in the liberation state, and the swing lever 2 is at the movement position, so that the rotation body 31 (and the second axis (A2)) is at the lowest position in the top-bottom direction (D3).

It should be noted that, during the rotation of the rotation member 3 from the transition position to the second position, the limitation unit 4 is in the liberation state, so the swing lever 2 is not limited by the limitation unit 4; however, the engagement between the second slide portion 312 and the guide portion 151 of the second engagement groove 15 restricts the position of the first slide portion 311 (and the second axis (A2)), which prevents the swing lever 2 from pivoting arbitrarily. In other words, although the swing lever 2 is not limited by the limitation unit 4 during the rotation of the rotation member 3 from the transition position to the second position, the position of the swing lever 2 is still controlled by the rotation member 3 (specifically, the rotation angle of the rotation member 3) and is not arbitrarily moved to make the user have a loose hand feel.

During the rotation of the rotation member 3 from the transition position to the second position, the engagement between the second slide portion 312 and the guide portion 151 of the second engagement groove 15 allows the swing lever 2 to pivot to the movement position, causing the rotation body 31 (and the second axis (A2)) to move to the lowest position. This enables the second case body that is disposed on the rotation member 3 to be at the lowest position, thereby preventing the second case body from blocking the exhaust vents that are located at the lower rear of the first case body; specifically, in this embodiment, the second case body is spaced apart from the first case body in the top-bottom direction (D3) at this time, but the disclosure is not limited thereto.

As described above, during the rotation of the rotation member 3 from the first position to the transition position, the limitation unit 4 limits the swing lever 2 at the initial position, so that the rotation body 31 is at a high position in the top-bottom direction (D3). During the rotation of the rotation member 3 from the transition position to the second position, the engagement between the second slide portion 312 and the guide portion 151 of the second engagement groove 15 allows the swing lever 2 to pivot to the movement position, thereby enabling the rotation body 31 to move to the lowest position. Thus, during the opening and shutting of the electronic device that includes the hinge device 100, the second case body may be prevented from blocking exhaust vents that are located at the lower rear of the first case body at most common angles, thereby preventing the heat dissipation performance of the electronic device from being affected.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A hinge device, comprising:
a base seat having a first engagement groove and a second engagement groove that are recessed in a left-right direction, said first engagement groove having a curved shape, said second engagement groove having a guide portion;
a swing lever mounted on said base seat and being pivotable about a first axis, which extends in the left-right direction, relative to said base seat between an initial position and a movement position;
a rotation member mounted on said swing lever and being rotatable about a second axis, which extends in the left-right direction, relative to said swing lever between a first position, a transition position and a second position, said rotation member having a first slide portion that slidably extends through said first engagement groove, and that extends along the second axis, and a second slide portion that is slidable along said second engagement groove; and
a limitation unit mounted on said rotation member and being operable to be driven by said rotation member, said limitation unit being able to switch between a restriction state, where said swing lever is limited at the initial position, and a liberation state, where said swing lever is not limited;
wherein, when said rotation member is at the first position, said limitation unit is in the restriction state, and said swing lever is at the initial position,
wherein, when said rotation member rotates from the first position to the transition position, said limitation unit is driven by said rotation member to switch into the liberation state, and said swing lever is at the initial position, and
wherein, when said rotation member rotates from the transition position to the second position, said swing lever is at the movement position, and said second slide portion slides along said guide portion of said second engagement groove.

2. The hinge device as claimed in claim 1, wherein:
said second engagement groove further has an arc portion that is in spatial communication with said guide portion at an end thereof and that opens at another end thereof, said arc portion having a radius of curvature that is equal to a distance between a center of said second slide portion and the second axis;
when said rotation member is at the first position, said second slide portion does not enter said second engagement groove; and
when said rotation member rotates from the first position to the transition position, said second slide portion slides along said arc portion to a junction between said guide portion and said arc portion.

3. The hinge device as claimed in claim 2, wherein said guide portion is straight and is tangent to said arc portion.

4. The hinge device as claimed in claim 1, wherein:
said base seat further has a pivot portion that extends along the first axis; and
said swing lever has a first end portion that is connected to said pivot portion, and a second end portion that is opposite to said first end portion, said rotation member rotatably extending through said second end portion of said swing lever.

5. The hinge device as claimed in claim 4, wherein:
said limitation unit has a driver member that is mounted on said rotation member, and that is operable to be driven by said rotation member to pivot synchronously, a secure member that is disposed on said pivot portion of said base seat, and a slider member that is mounted to said swing lever and that is located between said driver member and said secure member;
said driver member has a first accommodation portion, said secure member having a second accommodation portion, said slider member being slidable, relative to said swing lever, between said driver member and said secure member to be partially received in said first accommodation portion and/or said second accommodation portion;
when said rotation member is at the first position, said first accommodation portion of said driver member is oriented away from said slider member, said slider member cannot be slid and is partially received in said second accommodation portion of said secure member, and said limitation unit is in the restriction state, so that said swing lever cannot be pivoted relative to said base seat and remains at the initial position; and
when said rotation member is at the transition position, said first accommodation portion of said driver member is oriented toward said slider member, said slider member is slidable to be partially received in said first accommodation portion and/or said second accommodation portion, and said limitation unit is in the liberation state, so that said swing lever is pivotable relative to said base seat.

6. The hinge device as claimed in claim 5, wherein:
said base seat and said swing lever define an accommodation space therebetween, said accommodation space accommodating said driver member, said secure member and said slider member; and
said swing lever further has a slide groove that is recessed in the left-right direction, and that is located between said first end portion and said second end portion, said slider member having a slide protrusion that is slidably disposed in said slide groove.

7. The hinge device as claimed in claim 1, further comprising a torque module that is sleeved on said rotation member, that abuts against said swing lever, and that is operable to be driven by said rotation member to rotate, wherein when said rotation member rotates, said torque module and said swing lever resist rotation of said rotation member by friction generated therebetween.

8. An electronic device, comprising:
a first case body, a second case body and said hinge device as claimed in claim 1, wherein said first case body and said second case body are connected to each other by said hinge device, so that said second case body is movable relative to said first case body.
